(19) United States
(12) Patent Application Publication
(10) Pub. No.: US 2013/0286205 A1
(43) Pub. Date: Oct. 31, 2013

(54) APPROACHING OBJECT DETECTION DEVICE AND METHOD FOR DETECTING APPROACHING OBJECTS

(71) Applicant: FUJITSU LIMITED, Kawasaki-shi (JP)

(72) Inventors: Yasutaka OKADA, Kawasaki (JP); Masami Mizutani, Kawasaki (JP)

(73) Assignee: FUJITSU LIMITED, Kawasaki-shi (JP)

(21) Appl. No.: 13/756,958

(22) Filed: Feb. 1, 2013

(30) Foreign Application Priority Data
Apr. 27, 2012 (JP) 2012-103630

(51) Int. Cl. H04N 7/18

(52) U.S. Cl. CPC H04N 7/18
USPC 348/148

(57) ABSTRACT

An approaching object detection device that detects moving objects approaching a vehicle on the basis of images generated by an image pickup unit that captures images of surroundings of the vehicle at certain time intervals, the approaching object detection device includes: a processor; and a memory which stores a plurality of instructions, which when executed by the processor, cause the processor to execute, detecting moving object regions that each include a moving object from an image; obtaining a moving direction of each of the moving object regions; and determining whether or not the moving object included in each of the moving object regions is a moving object approaching the vehicle on the basis of at least either an angle between the moving direction of each of the moving object regions in the image and a horizon in the image or a ratio of an area of a subregion.

### CROSS-REFERENCE TO RELATED APPLICATION(S)

This application is based upon and claims the benefit of priority of the prior Japanese Patent Application No. 2012-103630, filed on Apr. 27, 2012, the entire contents of which are incorporated herein by reference.

### FIELD

The embodiment discussed herein is related to an approaching object detection device that detects moving objects approaching a vehicle on the basis of, for example, captured images of regions around the vehicle, a method for detecting approaching objects, and a computer-readable recording medium storing a computer program for detecting approaching objects.

### BACKGROUND

Currently, in order to suppress occurrence of collision accidents of vehicles, a technology for detecting moving objects approaching a vehicle and warning a driver of the vehicle is being studied.

For example, in Japanese Laid-open Patent Publication No. 2004-302621, a technology is disclosed in which a moving object that remains on a road connecting to a road on which a vehicle is running and that is located at a certain angular position in the horizontal direction relative to the traveling direction of the vehicle is determined to be likely to collide with the vehicle on the basis of images of a region ahead of the vehicle.

In addition, an obstacle approaching state detection device disclosed in Japanese Laid-open Patent Publication No. 8-147599 sets a plurality of horizontal scan lines including a processing target reference line as a processing target range in an image. The obstacle approaching state detection device obtains horizontal displacement vectors between two successive points of time for video signals on the processing target reference line at a certain point of time and a plurality of corresponding points on the horizontal scan lines within the processing target range at a next point of time. The obstacle approaching state detection device then detects an obstacle and determines whether or not the obstacle is in an approaching state on the basis of these displacement vectors.

In addition, in a method for monitoring the surroundings of a vehicle disclosed in Japanese Laid-open Patent Publication No. 2005-217482, a space-time image is created by accumulating line images in a certain number of frames using a plurality of inspection lines including a horizontal line that passes through the position of a vanishing point of a road along the vertical axis and lines parallel to the horizontal line provided close to the horizontal line in images obtained by capturing images of the surroundings of the vehicle. In the method for monitoring the surroundings of a vehicle, by performing an edge extraction process and a binarization process on the space-time image, an inclination block corresponding to a moving object is detected in the binarized image.

Furthermore, a vehicle surroundings monitoring device disclosed in Japanese Laid-open Patent Publication No. 2005-267331 sets horizontal lines in images of the surroundings of a vehicle. The vehicle surroundings monitoring device then detects a vanishing point in a plurality of images captured while the vehicle is stationary, and extracts line images having a certain width along the lines from the plurality of images captured while the vehicle is stationary, in order to generate a space-time image by arranging the plurality of extracted line images parallel to one another. The vehicle surroundings monitoring device then detects the moving direction of a moving body on the basis of the space-time image, and determines whether or not the moving body is approaching the vehicle on the basis of the detected moving direction of the moving body and the vanishing point.

Furthermore, in Kiyohara, et al. “Approaching Objects Detection via Optical Flow Method Using Monocular Noseview Cameras”, Vision Engineering Workshop 2009 (ViEW 2009), an algorithm is disclosed by which approaching objects are detected on the basis of images obtained by a nose view camera mounted on a front bumper of a vehicle such that an optical axis of the nose view camera is directed perpendicular to the traveling direction of the vehicle and horizontal to the road surface. The algorithm extracts regions that are apparently moving in the images and the amount of movement by calculating an optical flow for each feature point, and then extracts moving regions by performing clustering on regions having the similar amounts of movement. The algorithm then obtains the enlargement ratio of the moving regions using dynamic programming for the luminance value projection waveforms of the moving regions, and detects other vehicles approaching the vehicle on the basis of results of the dynamic programming, in order to suppress erroneous detection of other vehicles running parallel to the vehicle as approaching vehicles.

### SUMMARY

According to an aspect of the embodiments, an approaching object detection device that detects moving objects approaching a vehicle on the basis of images generated by an image pickup unit that captures images of surroundings of the vehicle at certain time intervals, the approaching object detection device includes: a processor; and a memory which stores a plurality of instructions, which when executed by the processor, cause the processor to execute, detecting moving object regions that each include a moving object from an image; obtaining a moving direction of each of the moving object regions; and determining whether or not the moving object included in each of the moving object regions is a moving object approaching the vehicle on the basis of at least either an angle between the moving direction of each of the moving object regions in the image and a horizon in the image or a ratio of an area of a subregion in which each of the moving object regions in the image and a past moving object region including the same moving object as each of the moving object regions in a past image generated immediately before the image overlap to an area of each of the moving object regions.

The object and advantages of the invention will be realized and attained by means of the elements and combinations particularly pointed out in the claims. It is to be understood that both the foregoing general description and the following detailed description are exemplary and explanatory and are not restrictive of the invention, as claimed.

### BRIEF DESCRIPTION OF DRAWINGS

These and/or other aspects and advantages will become apparent and more readily appreciated from the following description of the embodiments, taken in conjunction with the accompanying drawing of which:

FIG. 1 is a schematic diagram illustrating the configuration of a vehicle on which an approaching object detection device according to an embodiment is mounted;

FIG. 2 is a diagram illustrating the hardware configuration of the approaching object detection device according to the embodiment;

FIG. 3 is a functional block diagram of a control unit;

FIG. 4 is a diagram illustrating an example of an approaching object determination region;

FIG. 5A is a diagram illustrating an example of a change in the position of a moving object region at a time when a moving object included in the moving object region is running parallel to a vehicle;

FIG. 5B is a diagram illustrating an example of a change in the position of a moving object region at a time when a moving object included in the moving object region is approaching the vehicle;

FIG. 6A is a diagram illustrating an example of changes in the size of a moving object region at a time when a moving object included in the moving object region is running parallel to the vehicle;

FIG. 6B is a diagram illustrating an example of changes in the size of a moving object region at a time when a moving object included in the moving object region is approaching the vehicle; and

FIG. 7 is an operation flowchart illustrating a process for detecting approaching objects.

### DESCRIPTION OF EMBODIMENT

An approaching object detection device according to an embodiment will be described hereinafter with reference to the drawings.

The approaching object detection device detects moving object regions, each of which includes a moving object, from each of a plurality of images obtained by capturing images of the surroundings of a vehicle including a traveling direction of the vehicle. The approaching object detection device then determines whether or not the moving object included in each moving object region is approaching the vehicle, on the basis of an angle between the moving direction of the moving object region itself and a horizon in an image or the like without analyzing the luminance distribution of the moving object region. In the following description, a moving object approaching a vehicle on which the approaching object detection device is mounted will be referred to as an “approaching object” for the sake of convenience.

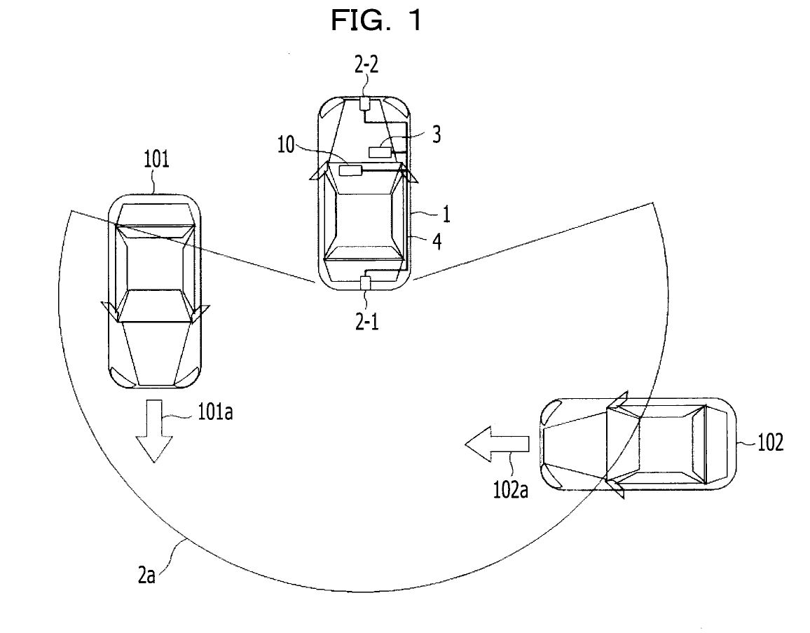

FIG. 1 is a schematic diagram illustrating the configuration of a vehicle on which the approaching object detection device according to the embodiment is mounted. As illustrated in FIG. 1, an approaching object detection device 10 is installed inside a vehicle 1. The approaching object detection device 10 is connected to vehicle-mounted cameras 2-1 and 2-2 and an electronic control unit 3 for controlling the vehicle through an in-vehicle network 4. The in-vehicle network 4 may be, for example, a network according to the Controller Area Network (CAN) standard.

The vehicle-mounted camera 2-1 is an example of an image pickup unit, and captures images of a region behind the vehicle 1 to generate the images of the region. For this purpose, the vehicle-mounted camera 2-1 includes a two-dimensional detector configured by an array of photoelectric conversion elements having sensitivity to visible light, such as a charge-coupled device (CCD) or a complementary metal-oxide-semiconductor (CMOS) device, and an image forming optical system that forms an image of a ground or a structure existing behind the vehicle 1 on the two-dimensional detector. For example, the vehicle-mounted camera 2-1 is disposed at substantially the center of a rear end of the vehicle 1 such that the optical axis of the image forming optical system becomes substantially parallel to the ground and is directed backward relative to the vehicle 1. In the present embodiment, in order to make it possible to capture images of a wide range behind the vehicle 1, a super-wide-angle camera whose horizontal angle of view is 180° or more is used as the vehicle-mounted camera 2-1. The vehicle-mounted camera 2-1 captures the images of the region behind the vehicle 1 at certain capture intervals (for example, 1/30 second) while the vehicle 1 is moving backward or stationary, and generates the images of the region.

The vehicle-mounted camera 2-2 is another example of the image pickup unit, and captures images of a region ahead of the vehicle 1 to generate the images of the region. For this purpose, for example, the vehicle-mounted camera 2-2 is disposed at a position close to an upper end of a windshield of the vehicle 1 or at a position close to a front grille of the vehicle 1 in such a way as to be directed forward. The vehicle-mounted camera 2-2 may be a super-wide-angle camera having the same configuration as the vehicle-mounted camera 2-1. The vehicle-mounted camera 2-2 captures the images of the region ahead of the vehicle 1 at the certain capture intervals (for example, 1/30 second) while the vehicle 1 is moving forward or stationary, and generates the images of the region.

The images generated by the vehicle-mounted cameras 2-1 and 2-2 may be color images or may be gray images.

Each time each of the vehicle-mounted cameras 2-1 and 2-2 generates an image, each of the vehicle-mounted cameras 2-1 and 2-2 transmits the generated image to the approaching object detection device 10 through the in-vehicle network 4.

The electronic control unit 3 controls each component of the vehicle 1 in accordance with a driving operation by a driver. For this purpose, each time a shift lever (not illustrated) is operated, the electronic control unit 3 obtains shift position information indicating the position of the shift lever from the shift lever through the in-vehicle network 4. The electronic control unit 3 also obtains, through the in-vehicle network 4, information relating to operations by the driver such as the amount by which an accelerator pedal is depressed and the steering angle of a steering wheel. The electronic control unit 3 also obtains, through the in-vehicle network 4, information indicating the behavior of the vehicle 1 such as the speed of the vehicle 1 from various sensors for measuring the behavior of the vehicle 1 such as a speed sensor (not illustrated) mounted on the vehicle 1. The electronic control unit 3 then controls an engine, a brake, or the like in accordance with these pieces of information.

When the shift position is a driving position, which indicates that the vehicle 1 is moving forward, or the like, the electronic control unit 3 causes the vehicle-mounted camera 2-2 to capture images. On the other hand, when the shift position is a reverse position, which indicates that the vehicle 1 is moving backward, the electronic control unit 3 causes the vehicle-mounted camera 2-1 to capture images.

Each time the shift position is changed, the electronic control unit 3 transmits the shift position information to the approaching object detection device 10 through the in-vehicle network 4. Furthermore, the electronic control unit 3 transmits speed information indicating the speed of the vehicle 1 and steering angle information indicating the steering angle of the steering wheel to the approaching object detection device 10 through the in-vehicle network 4 at regular intervals or each time the shift position is changed.

The approaching object detection device 10 receives the shift position information, the speed information, the steering angle information, and the like from the electronic control unit 3. On the basis of these pieces of information, the approaching object detection device 10 determines whether or not to detect approaching objects, and sequentially receives images captured by the vehicle-mounted camera 2-1 or the vehicle-mounted camera 2-2 at the certain time intervals through the in-vehicle network 4 while the approaching objects are being detected. The approaching object detection device 10 detects moving objects approaching the vehicle 1 on the basis of these images.

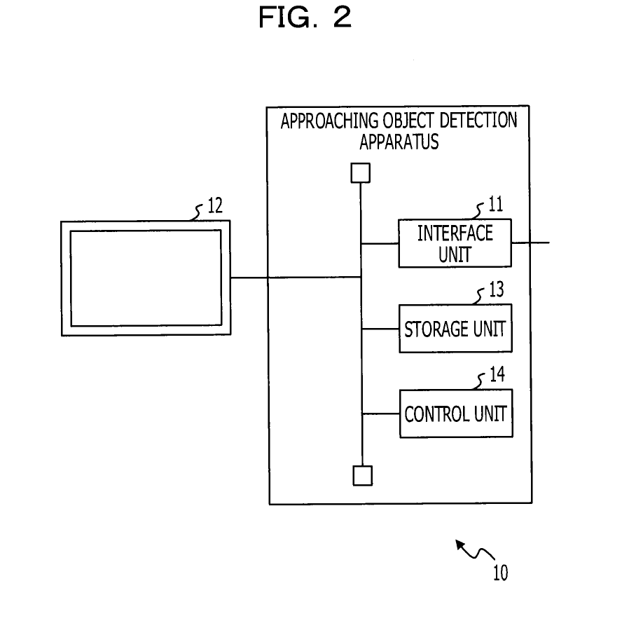

FIG. 2 is a diagram illustrating the hardware configuration of the approaching object detection device 10. The approaching object detection device 10 includes an interface unit 11, a display unit 12, a storage unit 13, and a control unit 14. The interface unit 11, the display unit 12, and the storage unit 13 are connected to the control unit 14 through a bus. The approaching object detection device 10 may further include a speaker (not illustrated), a light source (not illustrated) such as a light-emitting diode, or a vibrator (not illustrated) attached to the steering wheel, as an example of a warning unit that warns the driver that there is an approaching object.

The interface unit 11 includes an interface circuit for connecting the approaching object detection device 10 to the in-vehicle network 4. The interface unit 11 receives an image from the vehicle-mounted camera 2-1 or the vehicle-mounted camera 2-2 through the in-vehicle network 4, and transmits the image to the control unit 14. In addition, the interface unit 11 receives the shift position information, the steering angle information, and the speed information from the electronic control unit 3 through the in-vehicle network 4, and transmits these pieces of information to the control unit 14.

The display unit 12 is an example of the warning unit, and includes, for example, a liquid crystal display or an organic electroluminescent display. The display unit 12 is arranged in an instrument panel such that a display screen of the liquid crystal display or the organic electroluminescent display is directed to the driver. Alternatively, the display unit 12 may be provided separately from the instrument panel. The display unit 12 displays an image received from the control unit 14, a result of the detection of approaching objects, or the like.

The storage unit 13 includes, for example, a nonvolatile read-only semiconductor memory and a volatile readable/writable semiconductor memory. The storage unit 13 stores a computer program for performing a process for detecting approaching objects executed by the control unit 14, various pieces of data used by the computer program for performing the process for detecting approaching objects, results of intermediate processes, images received from the vehicle-mounted camera 2-1 or the vehicle-mounted camera 2-2, and the like.

The control unit 14 includes, for example, one or a plurality of processors, and detects approaching objects from a plurality of images captured at different times received from the vehicle-mounted camera 2-1 or the vehicle-mounted camera 2-2 by executing the computer program for performing the process for detecting approaching objects on the one or plurality of processors.

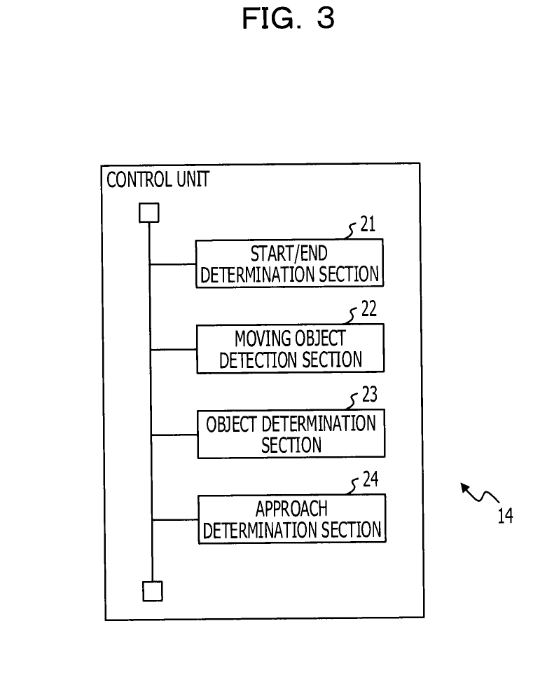

FIG. 3 is a functional block diagram of the control unit 14. The control unit 14 includes a start/end determination section 21, a moving object detection section 22, an object determination section 23, and an approach determination section 24. These sections included in the control unit 14 are, for example, installed as functional modules realized by the computer program for performing the process for detecting approaching objects executed on the one or plurality of processors included in the control unit 14.

Alternatively, these sections included in the control unit 14 may be installed in the approaching object detection device 10 as an integrated circuit such as a digital signal processing processor in which arithmetic circuits that realize the functions of these sections are integrated.

The start/end determination section 21 determines whether or not to start detection of approaching objects and whether or not to end the detection of approaching objects.

For example, upon receiving the shift position information indicating that the shift lever has been set to the reverse position, the start/end determination section 21 starts the detection of objects approaching the vehicle 1 from behind the vehicle 1. In this case, after the detection of approaching objects starts, the approaching object detection device 10 receives an image each time the vehicle-mounted camera 2-1, which captures images of the region behind the vehicle 1, generates an image, and sequentially displays the received images on the display unit 12. In addition, the control unit 14 reads data to be used for the process for detecting approaching objects from the storage unit 13.

Thereafter, each time the start/end determination section 21 receives the shift position information, the start/end determination section 21 refers to the shift position information and determines whether or not the shift lever has been set to a position indicating forward movement, such as the driving position, a second gear, or a third gear. If the shift lever has been set to a position indicating forward movement, the start/end determination section 21 refers to the latest speed information and steering angle information, and compares the speed of the vehicle 1 with a certain speed threshold and the steering angle with a certain angle threshold. If the speed of the vehicle 1 is equal to or higher than the certain speed threshold and the steering angle is smaller than or equal to the certain angle threshold, the start/end determination section 21 may determine that the vehicle is moving forward, and ends the detection of approaching objects. The control unit 14 then stops receiving images from the vehicle-mounted camera 2-1 and displaying the images on the display unit 12.

The speed threshold is set to a minimum value of speed at which it may be determined that the vehicle 1 has begun normal forward driving, namely, for example, 10 km/h, and the angle threshold is set to the angle of play in the steering wheel. Thus, by determining the end of the detection of approaching object using the start/end determination section 21, for example, it is possible to avoid frequent repetition of starting and ending of the detection of approaching objects while the driver of the vehicle 1 is performing a steering operation to get out of a parking space. Therefore, the driver may operate the vehicle more comfortably.

In addition, in order to determine whether or not to start the detection of objects approaching from ahead of the vehicle 1, the vehicle 1 determines, each time the shift position information is received, whether or not the shift lever has been set to a position indicating forward movement by referring to the shift position information. If the shift lever has been set to a position indicating forward movement, the start/end determination section 21 refers to the latest speed information, and, if the speed of the vehicle 1 is equal to or higher than a second speed threshold, starts the detection of objects approaching from ahead of the vehicle 1. In this case, when the detection of approaching objects has begun, the approaching object detection device 10 receives an image each time the vehicle-mounted camera 2-2, which captures images of the region ahead of the vehicle 1, generates an image, and sequentially displays the received images on the display unit 12. The control unit 14 reads data to be used for the process for detecting approaching objects from the storage unit 13.

When the detection of objects approaching from ahead of the vehicle 1 is being performed, the start/end determination section 21 ends the detection of objects approaching from ahead of the vehicle 1 if the speed of the vehicle 1 becomes lower than or equal to a third speed threshold. The second speed threshold is set to, for example, 20 km/h, and the third speed threshold is set to a value smaller than the second speed threshold, namely, for example, 10 km/h.

After the detection of approaching objects begins, the moving object detection section 22 extracts feature points that might be points on a moving object included in a first received image. The moving object detection section 22 detects a corner included in the image by, for example, applying a Harris detector to the image. Alternatively, the moving object detection section 22 may use a detector of another type for extracting feature points in order to extracts the feature points from the image. As such a detector, for example, a Moravec detector, a Smallest Univalue Segment Assimilating Nucleus (SUSAN) detector, a Kanade-Lucas-Tomasi (KLT) tracker, or a Scale-Invariant Feature Transform (SIFT) detector may be used.

Next, the moving object detection section 22 sets a certain region (for example, horizontal 10 pixels×vertical 10 pixels) including each feature point as its center as a template. The moving object detection section 22 then sets, in a next image received thereby, a range in the image including each feature point as its center corresponding to an assumed maximum value of the relative movement speed of the approaching object as a search range. The moving object detection section 22 then performs, for each feature point, for example, template matching between the template and the next image received thereby while changing the relative position in the search range, in order to obtain the degree of similarity. The moving object detection section 22 then obtains the position of the center of the region matched to the template at a time when the degree of similarity becomes maximum as a feature point in the next image corresponding to each feature point in the first image. The moving object detection section 22 may calculate, for example, a normalized correlation coefficient, the reciprocal of a value obtained by adding 1 to the sum of absolute differences between corresponding pixels in the template and each image, or the reciprocal of a value obtained by adding 1 to the sum of squares of the differences between the corresponding pixels as the degree of similarity.

With respect to a feature point in the first image whose maximum value of the degree of similarity is smaller than or equal to a certain threshold, the moving object detection section 22 may determine that there is no feature point corresponding to the feature point in the next image. The certain threshold may be, for example, half the maximum value of the degree of similarity.

The moving object detection section 22 calculates a displacement vector (xᵢ₁-xᵢ₀, yᵢ₁-yᵢ₀) from the feature point (xᵢ₀, yᵢ₀) in the first image to the corresponding feature point (xᵢ₁, yᵢ₁) in the next image.

Each time an image is received, the moving object detection section 22 extracts, for pixels in the image that do not correspond to feature points in a previous image, feature points using the detector for extracting feature points, as in the case of the first image.

Similarly, the moving object detection section 22 extracts, in each image received thereafter, feature points corresponding to feature points extracted in a previous image. At this time, if a displacement vector has been obtained for a feature point in the previous image, the moving object detection section 22 sets a search range using a position obtained by moving the feature point by the displacement vector for the feature point as its center. The moving object detection section 22 then extracts, in the search range, a position at which the degree of similarity becomes maximum as a feature point while changing the relative position of the image and a template obtained from the previous image. The moving object detection section 22 then calculates a displacement vector (xᵢₜ-xᵢₜ₋₁, yᵢₜ-yᵢₜ₋₁) from the feature point (xᵢₜ₋₁, yᵢₜ₋₁) in the previous image to the corresponding feature point (xᵢₜ, yᵢₜ) in the current image.

If the magnitude of a displacement vector is smaller than or equal to a certain threshold, the moving object detection section 22 may delete the two feature points while determining that the feature point in the current image and the feature point in the previous image corresponding to the displacement vector correspond to a stationary object. The certain threshold may be, for example, the magnitude of a displacement vector corresponding to a moving object that moves at a speed of 5 km/h.

The moving object detection section 22 groups, in each image, feature points whose magnitudes and directions of displacement vectors are close to one another and that are located close to one another together. Here, because of the installed positions and capture directions of the vehicle-mounted cameras 2-1 and 2-2, the horizontal component of the displacement direction of an approaching object in each image approaches a vanishing point in the image. Therefore, the moving object detection section 22 extracts only feature points whose horizontal components of displacement vectors point to the right from feature points located on the left of a position corresponding to the vanishing point in each image. Similarly, the moving object detection section 22 extracts only feature points whose horizontal components of displacement vectors point to the left from feature points located on the right of the position corresponding to the vanishing point in each image.

If the absolute value of the difference between the directions of two displacement vectors is smaller than or equal to a certain angular difference threshold and the ratio of the magnitudes of the two displacement vectors is smaller than or within a certain range, the moving object detection section 22 determines that the two displacement vectors are similar to each other. The angular difference threshold is set to, for example, 5°, and the range of ratios is set to, for example, 0.8 to 1.2. If the distance between two feature points is smaller than or equal to an assumed maximum value of the size of the image of an approaching object in an image, the moving object detection section 22 determines that the two feature points are located close to each other.

The moving object detection section 22 detects a bounding rectangle of feature points belonging to each group as a moving object region including a moving object, and determines a mean or a median of the displacement vectors of the feature points belonging to each group as the displacement vector of the moving object region. In addition, the moving object detection section 22 calculates the number of pixels included in each moving object region as the area of each moving object region. Furthermore, the moving object detection section 22 identifies, for each moving object region detected in a current image, a moving object region in a previous image that is assumed to include the same moving object as each moving object region in the current image. For example, the moving object detection section 22 identifies a moving object region detected from the current image that is the closest to a position obtained by moving the position of the center of gravity of the moving object region detected in the previous image by the displacement vector of the moving object region. The moving object detection section 22 then estimates that the two moving object regions include the same moving object, and associates the two moving object regions with each other.

Alternatively, the moving object detection section 22 may associate moving object regions detected from a plurality of images with one another by using one of various other tracking methods for associating regions including the same subject with one another in a plurality of chronologically successive images, instead.

The moving object detection section 22 stores the coordinates of the center of gravity, the coordinates of each vertex, and the area of each moving object region detected in a current image, each object region, and the coordinates of the center of gravity of a corresponding moving object region in a previous image in the storage unit 13.

Each time an image is obtained, the object determination section 23 identifies a moving object region to be subjected to a determination as to whether or not a moving object included in the moving object region is an approaching object from among moving object regions detected in each image.

In FIG. 1, there is a vehicle 101 at a position close to a right end of a capture range 2a of the vehicle-mounted camera 2-1, and there is a vehicle 102 at a position close to a left end of the capture range 2a. The traveling direction of the vehicle 101 is represented by an arrow 101a, and the traveling direction of the vehicle 102 is represented by an arrow 102a. When the vehicle 1 moves backward, the vehicle 101 runs parallel to the vehicle 1 as indicated by the arrow 101a. On the other hand, as indicated by the arrow 102a, the vehicle 102 approaches the vehicle 1. Therefore, the approaching object detection device 10 is not to detect the vehicle 101 and is to detect the vehicle 102 as an approaching object.

However, in an image captured by the vehicle-mounted camera 2-1, both the vehicle 101 and the vehicle 102 move toward a vanishing point in the image. In particular, since the vehicle-mounted cameras 2-1 and 2-2 are super-wide-angle cameras, a change in the position at an edge of the image when a moving object moves in the real space by a certain distance is smaller than a change in the position at the center of the image when a moving object moves by the same distance. Therefore, it is difficult to accurately determine whether or not a moving object located at a position close to a left edge or a right edge of an image is an approaching object.

For this reason, the object determination section 23 does not determine whether or not a moving object included in a moving object region located a certain width or less away from the left edge or the right edge of an image. That is, the object determination section 23 sets a region located the certain width or more away from the left edge or the right edge of the image as an approaching object determination region, and determines only moving objects included in moving object regions whose centers of gravity are included in the approaching object determination region as targets of the determination of approaching objects.

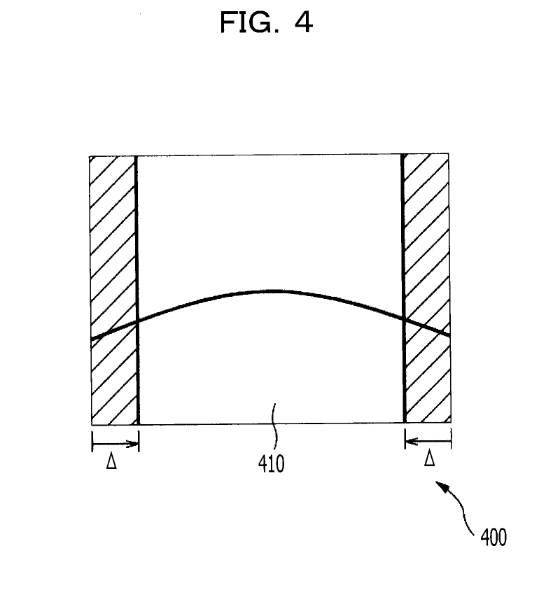

FIG. 4 is a diagram illustrating an example of the approaching object determination region. A position a width Δ away from a left edge of an image 400 is a left edge of an approaching object determination region 410, and a position Δ away from a right edge of the image 400 is a right edge of the approaching object determination region 410.

For example, the width Δ is set to a value obtained by multiplying a minimum value of the number of times tracking is performed to accurately determine whether or not the same moving object is an approaching object, that is, a minimum value of the number of images that include a moving object region including the same moving object, by the amount of movement of the moving object in each image in each capture interval.

For example, if the capture intervals are 33 ms, a moving object that is moving at a speed of 20 km/h covers a distance of about 19 cm in each capture interval. Since the number of pixels, the focal length, and the angle of view of the vehicle-mounted camera 2-1 are known, the number of pixels at a position close to an edge of an image corresponding to the moving distance in each capture interval may be calculated in advance for a moving object located a certain distance away from the vehicle 1. The minimum value of the number of times tracking is performed to accurately determine whether or not a moving object is an approaching object is, for example, experimentally determined in advance.

The width Δ when objects approaching from ahead of the vehicle 1 are detected on the basis of images from the vehicle-mounted camera 2-2 and the width Δ when objects approaching from behind the vehicle 1 are detected on the basis of images from the vehicle-mounted camera 2-1 may be different from each other. For example, when objects approaching from ahead of the vehicle 1 are to be detected, the approaching objects are assumed to be moving at relatively high speed because the vehicle 1 is running. On the other hand, when objects approaching from behind the vehicle 1 are to be detected, the approaching objects are likely to be moving at low speed because the vehicle 1 is assumed to be in a parking lot. Therefore, a certain width Δ′ from the left and right edges of an image when objects approaching from ahead of the vehicle 1 are to be detected may be set to a value larger than the certain width Δ when objects approaching from behind the vehicle 1 are to be detected. For example, when objects approaching from ahead of the vehicle 1 are to be detected, the speed of the approaching objects used to calculate the certain width Δ′ is set to, for example, 40 km/h. The certain widths Δ and Δ′ are stored in the storage unit 13 in advance.

The approach determination section 24 determines whether or not a moving object included in each moving object region included in the approaching object determination region is an approaching object.

In the present embodiment, the approach determination section 24 calculates an angle between the moving direction of a target moving object region and the horizon in an image and the overlap ratio and the area ratio of moving object regions in chronologically successive images as determination values to be used for an approach determination. If any of the determination values satisfies an approach determination condition, the approach determination section 24 determines a moving object included in the moving object region as an approaching object.

First, the angle between the moving direction of a moving object region and the horizon in an image will be described as a first determination value.

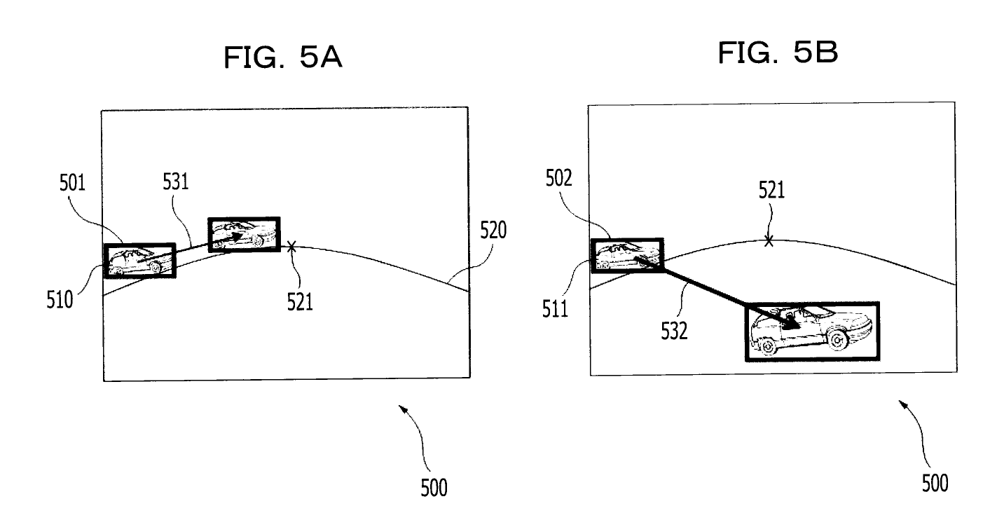

FIG. 5A is a diagram illustrating an example of a change in the position of a moving object region at a time when a moving object included in the moving object region is a moving object running parallel to the vehicle 1. On the other hand, FIG. 5B is a diagram illustrating an example of a change in the position of a moving object region at a time when a moving object included in the moving object region is an object approaching the vehicle 1.

As illustrated in FIG. 5A, a moving object running parallel to the vehicle 1 normally enters the capture range of the vehicle-mounted camera 2-1 or the vehicle-mounted camera 2-2 from the left end or the right end of the field of view of the vehicle-mounted camera 2-1 or the vehicle-mounted camera 2-2. Therefore, a moving object region 501 including a moving object 510 running parallel to the vehicle 1 first appears at a position close to a left edge or a right edge of an image 500. Thereafter, an angle between a line connecting the vehicle-mounted camera 2-1 or the vehicle-mounted camera 2-2 and the moving object 510 and the optical axis of the vehicle-mounted camera 2-1 or the vehicle-mounted camera 2-2 becomes smaller as the moving object 510 running parallel to the vehicle 1 becomes more distant from the vehicle 1 in the traveling direction of the vehicle 1. Therefore, the moving object region 501 including the moving object 510 approaches the center of the image 500. On the other hand, as the moving object region 501 approaches the center of the image 500, the distance between the vehicle 1 and the moving object 510 becomes larger. Therefore, as indicated by an arrow 531, the moving object region 501 moves toward a vanishing point 521 of the image 500 along a horizon 520 in the image 500.

On the other hand, as illustrated in FIG. 5B, an object approaching the vehicle 1, too, enters the capture range of the vehicle-mounted camera 2-1 or the vehicle-mounted camera 2-2 from the left end or the right end of the field of view of the vehicle-mounted camera 2-1 or the vehicle-mounted camera 2-2. Therefore, a moving object region 502 including an approaching object 511 first appears at the left edge or the right edge of the image 500. Thereafter, an angle between a line connecting the vehicle-mounted camera 2-1 or the vehicle-mounted camera 2-2 and the approaching object 511 and the optical axis of the vehicle-mounted camera 2-1 or the vehicle-mounted camera 2-2 becomes smaller as the approaching object 511 becomes closer to the vehicle 1. Therefore, the moving object region 502 including the approaching object 511, too, approaches the center of the image 500. In this case, as the approaching object 511 approaches the center of the capture range, the distance between the vehicle 1 and the approaching object 511 becomes smaller. As a result, as indicated by an arrow 532, the moving object region 502 moves in a downward direction relative to the vanishing point 521 in the image 500, that is, in a closer direction.

Thus, an angle between the moving direction of a moving object region and the horizon is different between an object approaching the vehicle 1 and a moving object running parallel to the vehicle 1.

Therefore, the approach determination section 24 calculates an angle between the moving direction of each moving object region included in the approaching object determination region and the horizon in an image. Since the focal distances, the angles of view, the installed positions, and the capture directions of the vehicle-mounted cameras 2-1 and 2-2 are known, the position of the horizon in the image may be obtained in advance. The coordinates of pixels representing the horizon in the image and the coordinates of the vanishing point are stored in the storage unit 13 in advance.

The approach determination section 24 determines a difference between the position of the center of gravity of a moving object region to be focused upon in a current image and the position of the center of gravity of a corresponding moving object region in a previous image as the displacement vector of the moving object region. Alternatively, the approach determination section 24 may use a displacement vector of the moving object region to be focused upon itself calculated in the current image.

The approach determination section 24 obtains a position at which the displacement vector and the horizon in the image intersect. The approach determination section 24 then calculates an angle θ between a tangential direction of the horizon and the displacement vector at the intersection as the first determination value. At this time, the approach determination section 24 uses the positive sign for the angle θ when the displacement direction points downward in the image compared to the tangential direction of the horizon, and uses the negative sign for the angle θ when the displacement direction points upward in the image compared to the tangential direction of the horizon.

When the angle θ is equal to or larger than a certain angle threshold Th_{θ}, the approach determination section 24 determines that the first determination value satisfies the approach determination condition, and determines the moving object included in the moving object region as an approaching object. The angle threshold Th_{θ} is set to a lower limit value of an angle indicating that the displacement vector points in a closer direction relative to the vanishing point in the image, namely, for example, 10° to 20°.

Next, the overlap ratio of moving object regions in two consecutive images will be described as a second determination value.

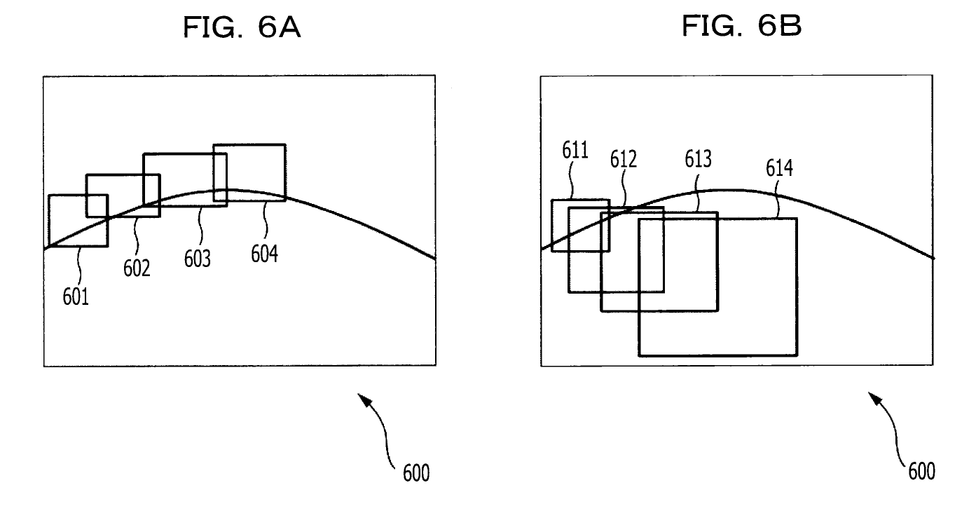

FIG. 6A is a diagram illustrating an example of changes in the size of a moving object region at a time when a moving object included in the moving object region is a moving object running parallel to the vehicle 1. On the other hand, FIG. 6B is a diagram illustrating an example of changes in the size of a moving object region at a time when a moving object included in the moving object region is an object approaching the vehicle 1.

In FIG. 6A, a moving object region 601 at a time (t−3), a moving object region 602 at a time (t−2), a moving object region 603 at a time (t−1), and a moving object region 604 at a time t are included in an image 600. Similarly, in FIG. 6B, a moving object region 611 at the time (t−3), a moving object region 612 at the time (t−2), a moving object region 613 at the time (t−1), and a moving object region 614 at the time t are included in an image 610.

In the present embodiment, since super-wide-angle cameras are used as the vehicle-mounted cameras 2-1 and 2-2, the size of the real space corresponding to one pixel at the periphery of an image is significantly larger than the size of the real space corresponding to one pixel at the center of the image due to the distortion aberration characteristics of image pickup optical systems of the vehicle-mounted cameras 2-1 and 2-2. With respect to a moving object running parallel to the vehicle 1, as described above, the closer a moving object region including the moving object running parallel to the vehicle 1 is to the center of an image, the more the moving object is distant from the vehicle 1 in the traveling direction of the vehicle 1. Therefore, as indicated by the moving object regions 601 to 604, the size of a moving object region including a moving object running parallel to the vehicle 1 remains small. In addition, when the distance from the moving object running parallel to the vehicle 1 to the vehicle 1 changes, an angle between a line connecting the vehicle-mounted camera 2-1 or 2-2 and the moving object and the optical axis of the vehicle-mounted camera 2-1 or 2-2 changes in accordance with the distance, and therefore the position of the moving object running parallel to the vehicle 1 also changes in an image. As a result, with respect to the moving object running parallel to the vehicle 1, the overlap ratio of the moving object regions in consecutive images is relatively small.

On the other hand, in the case of an object approaching the vehicle 1, the approaching object might move such that an angle between a line connecting the approaching object and the vehicle-mounted camera 2-1 or 2-2 and the optical axis of the vehicle-mounted camera 2-1 or 2-2 remains substantially the same. In this case, because the position of the approaching object hardly changes in images, the overlap ratio is relatively large as indicated by the moving object regions 611 to 614. In particular, when the angle between the line connecting the vehicle-mounted camera 2-1 or 2-2 and the approaching object and the optical axis of the vehicle-mounted camera 2-1 or 2-2 is relatively large, changes in the angle caused by the movement of the moving object at the capture intervals are small, and therefore the overlap ratio is relatively large. In addition, when the distortion aberration of the vehicle-mounted camera 2-1 or 2-2 is significantly large, changes in the size of a moving object region at the capture intervals are larger than changes in the position of the moving object region even if the angle between the line connecting the vehicle-mounted camera 2-1 or 2-2 and the approaching object and the optical axis of the vehicle-mounted camera 2-1 or 2-2 is relatively small. As a result, the overlap ratio is relative large.

Therefore, the approach determination section 24 calculates the ratio (Sₒ/Sₜ) of an area Sₒ of a subregion in which a moving object region to be focused upon in a current image and a corresponding moving object region in a previous image overlap to an area Sₜ of the moving object region to be focused upon as the overlap ratio, which is the second determination value. If the overlap ratio (Sₒ/Sₜ) is larger than a certain threshold Tho, the approach determination section 24 determines that the second determination value satisfies the approach determination condition, and determines the moving object included in the approach object region as an approaching object. The threshold Tho is set to an upper limit value of the overlap ratio at an assumed speed of the moving object running parallel to the vehicle 1 relative to the speed of the vehicle 1 or a value obtained by adding a positive offset to the upper limit value, namely, for example, 0.5 to 0.6. With respect to the threshold Tho, an assume speed of a moving object approaching from behind the vehicle 1 is lower than an assumed speed of a moving object approaching from ahead of the vehicle 1. Therefore, the threshold Tho for images obtained by the vehicle-mounted camera 2-1, which captures the images of the region behind the vehicle 1, may be smaller than the threshold Tho for images obtained by the vehicle-mounted camera 2-2, which captures the images of the region ahead of the vehicle 1.

Finally, the area ratio of moving object regions in two consecutive images will be described as a third determination value.

As described above, the area of a moving object region including a moving object running parallel to the vehicle 1 does not become larger even if the moving object region approaches the center of an image. Therefore, the ratio of the areas of corresponding moving object regions in two consecutive images is a value close to 1.

On the other hand, the area of a moving object region including an object approaching the vehicle 1 becomes larger as the approaching object approaches the vehicle 1.

For example, in FIG. 6A, the areas of the moving object regions 601 to 604 including the moving object running parallel to the vehicle 1 are substantially the same. On the other hand, as indicated by FIG. 6B, the areas of the moving object regions 611 to 614 including the object approaching the vehicle 1 are different from one another, that is, the area of the moving object region becomes larger as time elapses.

Therefore, the approach determination section 24 calculates the ratio (Sₜ/Sₜ₋₁) of an area Sₜ of a moving object region to be focused upon in a current image to an area Sₜ₋₁ of a corresponding moving object region in a previous image as the area ratio, which is the third determination value. If the area ratio (Sₜ/Sₜ₋₁) is larger than a certain threshold Ths, the approach determination section 24 judges that the third determination value satisfies the approach determination condition, and determines the moving object included in the moving object region as an approaching object. The threshold Ths is set to an upper limit value of the area ratio at an assumed speed of the moving object running parallel to the vehicle 1 relative to the speed of the vehicle 1 or a value obtained by adding a positive offset to the upper limit value, namely, for example, 1.1 to 1.2.

If the approach determination section 24 determines that there is an approaching object on the basis of any of the above-described three determination values, the control unit 14 displays a warning indicating the existence of the approaching object on the display unit 12. For example, the control unit 14 causes the contour of a moving object region determined to include an approaching object to blink. When the approaching object detection device 10 includes a speaker, the control unit 14 may cause the speaker to emit a warning tone. Alternatively, when the approaching object detection device 10 includes a light source, the control unit 14 may turn on the light source or may cause the light source to blink. Alternatively, when the approaching object detection device 10 includes a vibrator, the control unit 14 may cause the vibrator to vibrate.

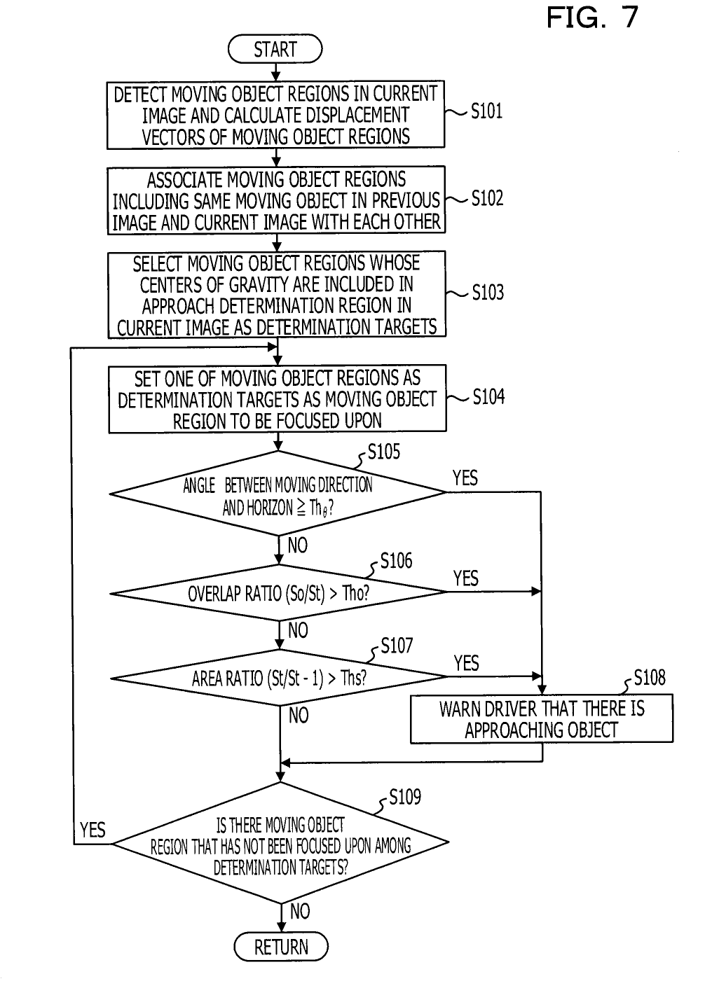

FIG. 7 is an operation flowchart illustrating a process for detecting approaching objects executed by the control unit 14. While the detection of approaching objects is being performed, the control unit 14 determines whether or not there is an approaching object in accordance with this operation flowchart each time an image is received.

The moving object detection section 22 detects moving object regions, each of which includes a moving object, in a current image, and calculates the displacement vectors of the moving object regions (step S101). The moving object detection section 22 then associates moving object regions including the same moving object in a previous image and the current image with each other (step S102).

The object determination section 23 selects moving object regions whose centers of gravity are included in the approaching object determination region in the current image as determination targets (step S103).

The approach determination section 24 sets one of the moving object regions as the determination targets as a moving object region to be focused upon (step S104).

The approach determination section 24 determines whether or not the angle θ between the moving direction of the moving object region to be focused upon and the horizon is equal to or larger than the threshold Th_{θ} (step S105).

If the angle θ is equal to larger than the threshold Th_{θ} (YES in step S105), the approach determination section 24 determines that the moving object region to be focused upon includes an approaching object. The control unit 14 warns the driver that there is an approaching object (step S108).

On the other hand, if the angle θ is smaller than the threshold Th_{θ} (NO in step S105), the approach determination section 24 determines whether or not the overlap ratio (Sₒ/Sₜ) is larger than the threshold Tho (step S106). If the overlap ratio (Sₒ/Sₜ) is larger than the threshold Tho (YES in step S106), the approach determination section 24 determines that the moving object region to be focused upon includes an approaching object. The control unit 14 warns the driver that there is an approaching object (step S108).

On the other hand, if the overlap ratio (Sₒ/Sₜ) is smaller than or equal to the threshold Tho (NO in step S106), the approach determination section 24 determines whether or not the area ratio (Sₜ/Sₜ₋₁) is larger than the threshold Ths (step S107). If the area ratio (Sₜ/Sₜ₋₁) is larger than the threshold Ths (YES in step S107), the approach determination section 24 determines that the moving object region to be focused upon includes an approaching object. The control unit 14 warns the driver that there is an approaching object (step S108).

On the other hand, if the area ratio (Sₜ/Sₜ₋₁) is smaller than or equal to the threshold Ths (NO in step S107), or after step S108, the approach determination section 24 determines whether or not there is a moving object region that has not been focused upon among the moving object regions as the determination targets (step S109). If there is a moving object region that has not been focused upon (YES in S109), the approach determination section 24 repeats the processing from step S104.

On the other hand, if there is no moving object region that has not been focused upon (NO in step S109), the control unit 14 ends the process for detecting approaching objects.

The approach determination section 24 may arbitrarily change the order in which the processing in steps S105 to S107 is performed.

As described above, the approaching object detection device determines whether or not a moving object is an approaching object on the basis of the determination values that are significantly different between a moving object running parallel to a vehicle on which the approaching object detection device is mounted and an object approaching the vehicle. Therefore, the approaching object detection device may detect an approaching object without recognizing a moving object running parallel to the vehicle as a moving object approaching the vehicle by mistake. In addition, these determination values may be obtained without analyzing the luminescence distribution of each moving object region and may be calculated even when a moving object region is small. Therefore, the approaching object detection device may warn the driver that there is an approaching object by detecting the approaching object while the approaching object is still distant from the vehicle.

According to a modification, an approach determination unit may calculate any one or two of the above-described first to third determination values, and determine whether or not a moving object included in a moving object region is an approaching object on the basis of the calculated determination value(s).

According to another modification, when a camera that captures images of a region behind the left rear of a vehicle and a camera that captures images of a region behind the right rear of the vehicle are separately provided, the approaching object detection device may detect approaching objects from images generated by each camera. In this case, each camera does not have to be a super-wide-angle camera, and therefore the distortion in the images generated by each camera, the distortion being caused by the distortion aberration of an image pickup optical system, might be small. In such a case, the approaching object detection device may accurately determine whether or not a moving object included in a moving object region is an approaching object even when the moving object region is located at a position close to an edge of the image. Therefore, in this case, the object determination section 23 may be omitted.

Alternatively, for example, the approaching object detection device 10 may be integrated into a navigation system (not illustrated) or a driving support apparatus (not illustrated). In this case, by executing a computer program for detecting approaching objects on a control unit of the navigation system or the driving support apparatus, the function of each component of the control unit 14 of the approaching object detection device illustrated in FIG. 3 is realized.

The computer program for detecting approaching objects that realizes the function of each component of the control unit 14 according to the embodiment or one of the modifications may be recorded on a portable computer-readable recording medium such as a semiconductor memory, a magnetic recording medium, or an optical recording medium, and provided. In this case, for example, the recording medium is set in a recording medium access device included in a navigation system, and the computer program for detecting approaching objects is loaded into the navigation system from the recording medium, in order to make it possible for the navigation system to execute the process for detecting approaching objects.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment of the present invention has been described in detail, it should be understood that the various changes, substitutions, and alterations could be made hereto without departing from the spirit and scope of the invention.

What is claimed is:

1. An approaching object detection device that detects moving objects approaching a vehicle on the basis of an image generated by an image pickup unit that captures the image of surroundings of the vehicle at certain time intervals, the approaching object detection device comprising:
a processor; and
a memory which stores a plurality of instructions, which when executed by the processor, cause the processor to execute,
detecting moving object regions that each include a moving object from the image;
obtaining a moving direction of each of the moving object regions; and
determining whether or not the moving object included in each of the moving object regions is a moving object approaching the vehicle on the basis of at least either an angle between the moving direction of each of the moving object regions in the image and a horizon in the image or a ratio of an area of a subregion in which each of the moving object regions in the image and a past moving object region including the same moving object as each of the moving object regions in a past image generated immediately before the image overlap to an area of each of the moving object regions.

2. The device according to claim 1,
wherein, in the determining, if the angle indicates that the moving direction of each of the moving object regions points in a closer direction relative to a vanishing point in the image, the moving object included in each of the moving object regions is determined as a moving object approaching the vehicle.

3. The device according to claim 1,
wherein, in the determining, if the ratio is larger than a first threshold, the moving object included in each of the moving object regions is determined as a moving object approaching the vehicle.

4. The device according to claim 3,
wherein the image pickup unit includes a first camera that captures images of a region behind the vehicle and a second camera that captures images of a region ahead of the vehicle, and
wherein the first threshold when whether or not a moving object included in an image generated by the second camera is a moving object approaching the vehicle is determined on the basis of the image generated by the second camera is set to be larger than the first threshold when whether or not a moving object included in an image generated by the first camera is a moving object approaching the vehicle is determined on the basis of the image generated by the first camera.

5. The device according to claim 3, further comprising:
not determining whether or not the moving object included in each of the moving object regions is a moving object approaching the vehicle when each of the moving object regions is located a certain width or less away from a left edge or a right edge of the image.

6. The method according to claim 5,
wherein the image pickup unit includes a first camera that captures images of a region behind the vehicle and a second camera that captures images of a region ahead of the vehicle, and
wherein the certain width for an image generated by the first camera is smaller than the certain width for an image generated by the second camera.

7. The device according to claim 1, further comprising:
starting, when information indicating that the vehicle is moving backward has been received from a control apparatus of the vehicle, a determination as to whether or not a moving object included in an image generated by a first camera, which is included in the image pickup unit and captures images of a region behind the vehicle, is approaching the vehicle, and ending, when information indicating that the vehicle is moving forward at a certain speed or more has been received from the control apparatus, the determination as to whether or not a moving object included in an image generated by the first camera is approaching the vehicle.

8. The device according to claim 1, further comprising:
warning, if the moving object included in each of the moving object regions is determined as a moving object approaching the vehicle, a driver of the vehicle that there is an approaching object.

9. A method for detecting approaching objects that detects moving objects approaching a vehicle on the basis of an image generated by an image pickup unit that captures the image of surroundings of the vehicle at certain time intervals, the method comprising:
detecting moving object regions that each include a moving object from the image;
obtaining a moving direction of each of the moving object regions; and
determining, by a computer processor, whether or not the moving object included in each of the moving object regions is a moving object approaching the vehicle on the basis of at least either an angle between the moving direction of each of the moving object regions in the image and a horizon in the image or a ratio of an area of a subregion in which each of the moving object regions in the image and a past moving object region including the same moving object as each of the moving object regions in a past image generated immediately before the image overlap to an area of each of the moving object regions.

10. The method according to claim 9,
wherein, in the determining, if the angle indicates that the moving direction of each of the moving object regions points in a closer direction relative to a vanishing point in the image, the moving object included in each of the moving object regions is determined as a moving object approaching the vehicle.

11. The method according to claim 9,
wherein, in the determining, if the ratio is larger than a first threshold, the moving object included in each of the moving object regions is determined as a moving object approaching the vehicle.

12. The method according to claim 11,
wherein the image pickup unit includes a first camera that captures images of a region behind the vehicle and a second camera that captures images of a region ahead of the vehicle, and
wherein the first threshold when whether or not a moving object included in an image generated by the second camera is a moving object approaching the vehicle is determined on the basis of the image generated by the second camera is set to be larger than the first threshold when whether or not a moving object included in an image generated by the first camera is a moving object approaching the vehicle is determined on the basis of the image generated by the first camera.

13. The method according to claim 9, further comprising:
not determining whether or not the moving object included in each of the moving object regions is a moving object approaching the vehicle when each of the moving object regions is located a certain width or less away from a left edge or a right edge of the image.

14. The method according to claim 13,
wherein the image pickup unit includes a first camera that captures images of a region behind the vehicle and a second camera that captures images of a region ahead of the vehicle, and
wherein the certain width for an image generated by the first camera is smaller than the certain width for an image generated by the second camera.

15. The method according to claim 9, further comprising:
starting, when information indicating that the vehicle is moving backward has been received from a control apparatus of the vehicle, a determination as to whether or not a moving object included in an image generated by a first camera, which is included in the image pickup unit and captures images of a region behind the vehicle, is approaching the vehicle, and ending, when information indicating that the vehicle is moving forward at a certain speed or more has been received from the control apparatus, the determination as to whether or not a moving object included in an image generated by the first camera is approaching the vehicle.

16. The method according to claim 9, further comprising:
warning, if the moving object included in each of the moving object regions is determined as a moving object approaching the vehicle, a driver of the vehicle that there is an approaching object.

17. A computer-readable storage medium storing a computer program for detecting approaching objects that detects moving objects approaching a vehicle on the basis of an image generated by an image pickup unit that captures the image of surroundings of the vehicle at certain time intervals, the computer program causing a computer to execute a process comprising:
detecting moving object regions that each include a moving object from the image;
obtaining a moving direction of each of the moving object regions; and
determining whether or not the moving object included in each of the moving object regions is a moving object approaching the vehicle on the basis of at least either an angle between the moving direction of each of the moving object regions in the image and a horizon in the image or a ratio of an area of a subregion in which each of the moving object regions in the image and a past moving object region including the same moving object as each of the moving object regions in a past image generated immediately before the image overlap to an area of each of the moving object regions.
